(19) United States
(12) Patent Application Publication
(10) Pub. No.: US 2010/0315746 A1
(43) Pub. Date: Dec. 16, 2010

(54) HEAD GIMBAL ASSEMBLY AND FIXING METHOD OF BASE PLATE AND CARRIAGE ARM

(75) Inventors: Kenichiro Aoki, Machida-shi (JP); Toshiyuki Nakada, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Storage Device Corporation, Tokyo (JP)

(21) Appl. No.: 12/850,562

(22) Filed: Aug. 4, 2010

Related U.S. Application Data
(63) Continuation of application No. PCT/JP2008/058820, filed on May 14, 2008.

(51) Int. Cl. G11B 21/16; G11B 5/127

(52) U.S. Cl. 360/245.3; 29/603.07; G9B/21.023; G9B/5.04

(57) ABSTRACT

According to one embodiment, a head gimbal assembly includes: base plate body; flexure; through hole passing through the base plate body; cylindrical base that upstands from the front surface of the base plate body, and has a first inner diameter; a cylindrical flange that continues to the base around the through hole and has a second inner diameter smaller than the first inner diameter; and inner wall surface that is defined by the flange and extends along a cylindrical surface formed by a generating line parallel to a central axis of the through hole. A ratio of a thickness T of the flange defined along a virtual plane orthogonal to the central axis of the through hole to a length L of the inner wall surface defined in a direction parallel to the central axis of the through hole is set to 1.5 or less.

### CROSS-REFERENCE TO RELATED APPLICATIONS

This application is a continuation of PCT international application Ser. No. PCT/JP2008/058820 filed on May 14, 2008 which designates the United States, incorporated herein by reference.

### FIELD

Embodiments described herein relate generally to a head gimbal assembly, for example, incorporated in a storage medium drive.

### BACKGROUND

For example, in a hard disk drive (HDD), a base plate is connected to the front end of a carriage arm by caulking. A base plate comprises a base plate body in a plate shape. The base plate body has a through hole passing therethrough from the front surface to the rear surface thereof. In the base plate body, a cylindrical boss is formed around the through hole. The boss defines a cylindrical base upstanding from the rear surface of the base plate body and a cylindrical flange continuing to the tip end of the base. The inner diameter of the flange is set smaller than that of the base.

Upon caulking of the base plate, the boss of the base plate is received in a caulking hole of the carriage arm. At this time, into the through hole of the base plate, a metallic ball for caulking is pushed. The diameter of the metallic ball is set larger than the inner diameter of the flange, and thus the flange is pressed toward the inner wall surface of the caulking hole as the metallic ball is pushed. The boss plastically deforms. Based on the plastic deformation of the boss, the base plate is fixed to the caulking hole of the carriage arm with a sufficient fixing force.

When the boss plastically deforms largely, the base plate is pulled into the caulking hole. Consequently, the base plate warps. The warpage of the base plate causes an adverse effect on the setting of the floating height of a flying head slider. To reduce the warpage, it is required to suppress the plastic deformation. To reduce the plastic deformation, it is required to suppress the contact friction between the metallic ball and the flange. However, through verification by the inventors, it has been confirmed that the warpage of the base plate cannot be reduced depending on a shape of the boss even when the contact friction is reduced.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view of an internal structure of a hard disk drive (HDD) as a storage medium drive according to an embodiment;

FIG. 2 is an exemplary plan view schematically illustrating a structure of a head suspension assembly of the embodiment;

FIG. 3 is an exemplary cross sectional view taken along the line 3-3 of FIG. 2 in the embodiment;

FIG. 4 is an exemplary partial enlarged cross sectional view schematically illustrating a structure of a boss in the embodiment;

FIG. 5 is an exemplary partial enlarged cross sectional view schematically illustrating a structure of a base plate in the embodiment;

FIG. 6 is an exemplary cross sectional view schematically illustrating a process of caulking the base plate to a carriage arm in the embodiment;

FIG. 7 is an exemplary partial enlarged cross sectional view schematically illustrating a process of caulking the base plate to the carriage arm in the embodiment;

FIG. 8 is an exemplary partial enlarged cross sectional view illustrating a position for measuring warpage upon simulation in the embodiment;

FIG. 9 is an exemplary graph representing a relationship between a ratio of the thickness T of a flange to the length L1 of an inner wall surface, and a reduce ratio of warpage, in the embodiment; and

FIG. 10 is an exemplary graph representing a relationship between a ratio of the thickness T of the flange to the length L2 of the flange, and a reduce ratio of warpage, in the embodiment.

### DETAILED DESCRIPTION

In general, according to one embodiment, a head gimbal assembly comprises: a base plate body formed in a plate shape; a load beam connected to a front end of the base plate body; a flexure fixed to a surface of the load beam; a through hole passing through the base plate body from a front surface to a rear surface thereof; a cylindrical base that continues to the base plate body around the through hole, upstands from the front surface of the base plate body, and has a first inner diameter; a cylindrical flange that continues to the base around the through hole and has a second inner diameter smaller than the first inner diameter; and an inner wall surface that is defined by the flange around the through hole and that extends along a cylindrical surface formed by a generating line parallel to a central axis of the through hole. The ratio of a thickness T of the flange defined along a virtual plane orthogonal to the central axis of the through hole to a length L of the inner wall surface defined in a direction parallel to the central axis of the through hole is set to 1.5 or less.

According to another embodiment, a head gimbal assembly comprises: a base plate body formed in a plate shape; a load beam connected to a front end of the base plate body; a flexure fixed to a surface of the load beam; a through hole passing through the base plate body from a front surface to a rear surface; a cylindrical base that continues to the base plate body around the through hole, upstands from the front surface of the base plate body, and has a first inner diameter; and a cylindrical flange that continues to the base around the through hole and has a second inner diameter smaller than the first inner diameter. The ratio of a thickness T of the flange defined along a virtual plane orthogonal to a central axis of the through hole to a length L of the flange defined in a direction parallel to the central axis of the through hole is set to 0.8 or less.

According to still another embodiment, a fixing method of a base plate and a carriage arm, the method comprises: fitting, into a caulking hole formed in the carriage arm, a boss formed around a through hole passing through a base plate body formed in a plate shape from a front surface to a rear surface thereof; and pushing a ball into the through hole and the caulking hole while reducing friction between the boss and the ball. The boss comprises: a cylindrical base that continues to the base plate body, upstands from the front surface of the base plate body, and has a first inner diameter; a cylindrical flange that continues to the base around the through hole and has a second inner diameter smaller than the first inner diameter; and an inner wall surface that is defined by the flange around the through hole and that extends along a cylindrical surface formed by a generating line parallel to a central axis of the through hole. The ratio of a thickness T of the flange defined along a virtual plane orthogonal to the central axis of the through hole to a length L of the inner wall surface defined in a direction parallel to the central axis of the through hole is set to 1.5 or less.

According to still another embodiment, a fixing method of a base plate and a carriage arm, the method comprises: fitting, into a caulking hole formed in the carriage arm, a boss formed around a through hole passing through a base plate body formed in a plate shape from a front surface to a rear surface thereof; and pushing a ball into the through hole and the caulking hole while reducing friction between the boss and the ball. The boss comprises: a cylindrical base that continues to the base plate body, upstands from the front surface of the base plate body, and has a first inner diameter; a cylindrical flange that continues to the base around the through hole and has a second inner diameter smaller than the first inner diameter; and an inner wall surface that is defined by the flange around the through hole and that extends along a cylindrical surface formed by a generating line parallel to a central axis of the through hole. The ratio of a thickness T of the flange defined along a virtual plane orthogonal to the central axis of the through hole to a length L of the flange defined in a direction parallel to the central axis of the through hole is set to 0.8 or less.

An embodiment will be described hereinafter with reference to the accompanying drawings.

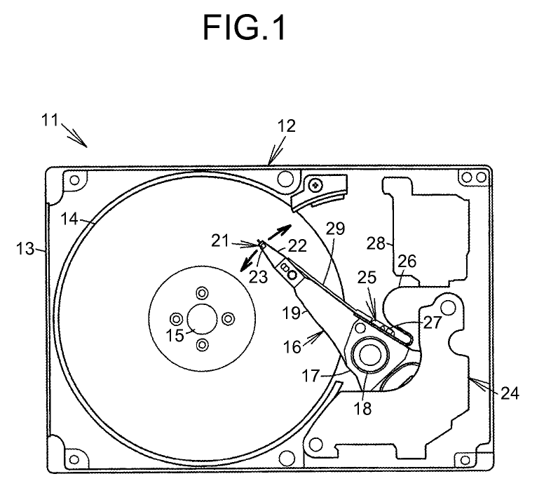

FIG. 1 schematically illustrates an internal structure of a hard disk drive (HDD) 11 as one specific example of a storage device. The HDD 11 comprises a housing 12. The housing 12 comprises a box-shaped base 13 and a cover (not illustrated). The base 13 defines, for example, a flat, rectangular parallelepiped internal space, or storage space. The base 13 may be formed by casting of a metal material such as aluminum. The cover is connected to an opening of the base 13. The storage space between the cover and the base 13 is closed hermetically. For example, the cover may be made of one plate material by press working.

In the storage space, at least one magnetic disk 14 is stored as a storage medium. The magnetic disk 14 is mounted on a rotation shaft of a spindle motor 15. The spindle motor 15 can rotate the magnetic disk 14 at high speed, such as 5,400 round per minute (rpm), 7,200 rpm, 10,000 rpm, or 15,000 rpm.

In the storage space, a carriage 16 is also provided. The carriage 16 comprises a carriage block 17, which is rotatably connected to a support shaft 18 extending in the vertical direction. In the carriage block 17, a plurality of carriage arms 19 is defined extending horizontally from the support shaft 18. For example, the carriage block 17 may be made of aluminum by extrusion.

To the end of each of the carriage arms 19, a head suspension assembly 21 is attached. The head suspension assembly 21 comprises a head suspension 22. The head suspension 22 extends frontward from the end of each of the carriage arm 19. At the front end of the head suspension 22, a flying head slider 23 is supported. On the flying head slider 23, an electromagnetic conversion element is mounted as the head element.

When air flow is generated on the surface of the magnetic disk 14 by rotation of the magnetic disk 14, the air flow acts so that the positive pressure, or equivalently, buoyant force and the negative pressure act on the flying head slider 23. When the buoyant force and the negative pressure equal a pressing force of the head suspension 22, the flying head slider 23 can be kept flying with relatively high rigidity during rotation of the magnetic disk 14.

When the carriage 16 rotates around the support shaft 18 while the flying head slider 23 is flying, the flying head slider 23 can move along the radial line of the magnetic disk 14. Consequently, the electromagnetic conversion element on the flying head slider 23 can come across the data zone between innermost recording track and the outermost recording track. Then, the electromagnetic conversion element on the flying head slider 23 can be positioned on a target recording track.

To the carriage block 17, for example, a power source such as a voice coil motor (VCM) 24 is connected. The action of the VCM 24 can rotate the carriage block 17 around the support shaft 18. Such rotation of the carriage block 17 is a basis to realize swinging of the carriage arm 19 and the head suspension 22.

As can be seen from FIG. 1, on the carriage block body 17, a flexible printed board unit 25 is arranged. The flexible printed board unit 25 comprises a head integrated circuit (IC) 27 mounted on a flexible printed board 26. Upon reading magnetic information, from the head IC 27 to a reading element of the electromagnetic conversion element, a sense current is supplied. Similarly, upon writing of magnetic information, from the head IC 27 to a writing element of the electromagnetic conversion element, a write current is supplied.

To the head IC 27, a sense current and a write current are supplied from a small circuit board 28 arranged in the storage space and a printed circuit board (not illustrated) attached to the rear of the bottom plate of the base 13. Upon supplying such a sense current and a write current, a flexure 29 is used. The flexure 29 has one end connected to the flexible printed board unit 25. The flexure 29 extends along a side edge of the carriage arms 19 and has the other end attached to the head suspension 22.

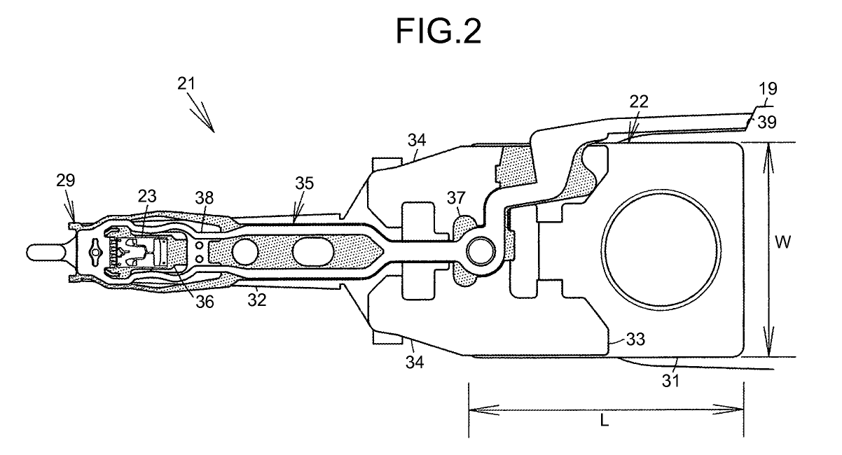

FIG. 2 schematically illustrates a structure of the head suspension assembly 21 according to the embodiment. The head suspension assembly 21 comprises a base plate 31 attached to the front end of the carriage arm 19 and a load beam 32 arranged in front of the base plate 31 with a predetermined space apart. On the surfaces of the base plate 31 and the load beam 32, a hinge plate 33 is fixed. The hinge plate 33 defines an elastic deformation portion 34 between the front end of the base plate 31 and the back end of the load beam 32. Accordingly, the hinge plate 33 connects the base plate 31 and the load beam 32. Each of the base plate 31, the load beam 32, and the hinge plate 33 may be made of, for example, a stainless steel plate. The width W of the base plate 31 is set to, for example, about 3.5 mm to 4.5 mm. In the embodiment, the width W is set to, for example, 4.5 mm. The length L of the base plate 31 in front and back direction is set to, for example, about 4.5 mm to 5.7 mm. In the embodiment, the length L is set to, for example, 5.5 mm.

The base plate 31, the load beam 32, and the hinge plate 33 constitute the head suspension 22. On the surface of the head suspension 22, the flexure 29 described above is attached. The flexure 29 comprises a stainless steel plate 35 as a flexure body. The stainless steel plate 35 comprises: a support plate 36 configured to receive the flying head slider 23 on the surface thereof; and a fixed plate 37 attached to the surface of the load beam 32 and the hinge plate 33. The fixed plate 37 may be fixed by spot welding at a plurality of welded-spots, for example. The flying head slider 23 is attached to the surface of the support plate 36. The support plate 36 and the fixed plate 37 are made of one thin plate of stainless steel.

On the surface of the fixed plate 37, a wiring pattern 38 is formed. One end of the wiring pattern 38 is connected to the flying head slider 23. At the side end of the base plate 31, the fixed plate 37 extends outwardly from the contour of the base plate 31. Outside of the contour of the base plate 31, the fixed plate 37 extends along a side edge of the carriage arm 19 to the flexible printed board unit 25. The fixed plate 37 is received in a groove 39 formed at the side edge of the carriage arm 19. Accordingly, the head suspension assembly 21 is forms in so-called long tail. The other end of the wiring pattern 38 is connected to the head IC 27. Consequently, the flying head slider 23 and the head IC 27 are electrically connected. The base plate 31, the load beam 32, the hinge plate 33, and the flexure 29 constitute a head gimbal assembly of this invention.

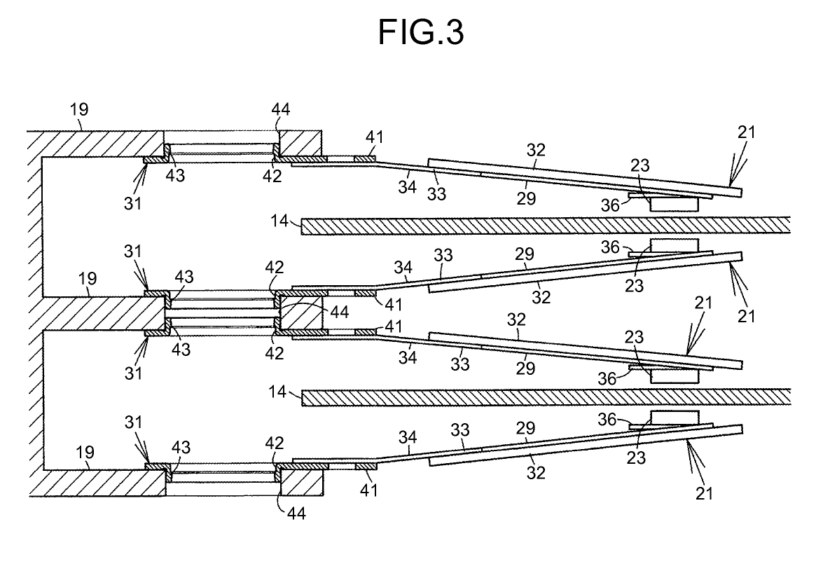

As illustrated in FIG. 3, the base plate 31 comprises a base plate body 41 in a plate shape, the rear surface of which is received by the front surface of the carriage arm 19. The thickness of the base plate body 41 is set to, for example, about 0.15 mm to 0.20 mm. In the embodiment, the thickness of the base plate body 41 is set to, for example, 0.15 mm. The base plate body 41 has a through hole 42 passing therethrough from the front surface to the rear surface thereof. The through hole 42 defines a cylindrical space. The base plate 31 comprises a boss 43 upstanding from the rear surface of the base plate body 41 around the through hole 42. The boss 43 is received in a caulking hole 44 formed in the front end of the carriage arm 19. The caulking hole 44 passes through the carriage arm 19 from the front surface to the rear surface thereof. The inner diameter of the caulking hole 44 is set to, for example, about 2.0 mm to 2.7 mm. In this embodiment, the inner diameter of the caulking hole 44 is set to, for example, 2.7 mm.

On the back side of the flying head slider 23, the support plate 36 is received by a domal projection (not illustrated) formed on the surface of the load beam 32. The elastic deformation portion 34 described above exercises a predetermined elasticity, that is, a bending force. The bending force acts so as to apply a pressing force, which is toward the surface of the magnetic disk 14, to the front end of the load beam 32. The pressing force acts on the flying head slider 23 from the back side of the support plate 36 with the action of the projection. The flying head slider 23 can change the attitude by the buoyant force generated by the air flow. The projection allows an attitude change of the flying head slider 23 and then allows that of the support plate 36.

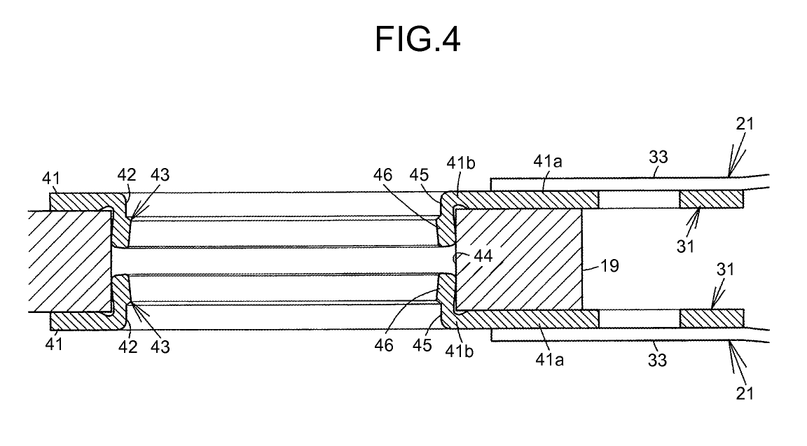

As illustrated in FIG. 4, the boss 43 of the base plate 31 comprises a cylindrical base 45 continuing to the base plate body 41 around the through hole 42. The base 45 upstands from the rear surface of the base plate body 41. The base plate body 41 defines a thick portion 41a having a uniform thickness and a thin portion 41b having a less thickness than the thick portion 41a. The base plate body 41 continues to the base 45 of the boss 43 at the thin portion 41b thereof. The thin portion 41b is formed in an annular shape. The base 45 continues to a cylindrical flange 46 extending on the periphery of the through hole 42. The flange 46 has a second inner diameter smaller than a first inner diameter of the base 45. The flange 46 is pressed to the inner peripheral surface of the caulking hole 44 due to the plastic deformation. The plastic deformation is realized by caulking to be described below. Accordingly, the base plate 31 and then the head suspension 22 is attached to the front end of the carriage arm 19.

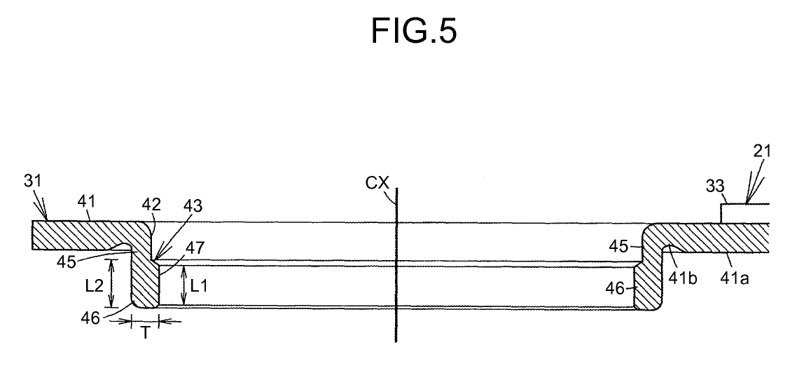

Next, a method of manufacturing the carriage 16 is explained. Prior to manufacturing the carriage 16, the head the head suspension 22, the flexure 29 is attached on the surface of the head suspension 22. On the support plate 36 of the flexure 29, the flying head slider 23 is fixed. As illustrated in FIG. 5, in the base plate 31, the flange 46 of the boss 43 defines an annular inner wall surface 47. The inner wall surface 47 is defined along a virtual cylindrical surface around a central axis CX of the through hole 42 obtained by a generating line parallel to the central axis CX.

The length L1 of the inner wall surface 47 of the flange 46 is defined in a direction parallel to the central axis CX of the through hole 42. The length L2 of the flange 46 is defined in a direction parallel to the central axis CX of the through hole 42. Similarly, the thickness T of the flange 46 is defined along a virtual plane orthogonal to the central axis CX of the through hole 42. In this embodiment, a ratio R1 of the thickness T of the flange 46 to the length L1 of the inner wall surface 47 is set to 1.5 or less. Also, a ratio R2 of the thickness T of the flange 46 to the length L2 of the flange 46 is set to 0.8 or less. Upon setting these ratios R1 and R2, for example, the thickness T of the flange 46 is always set to constant value.

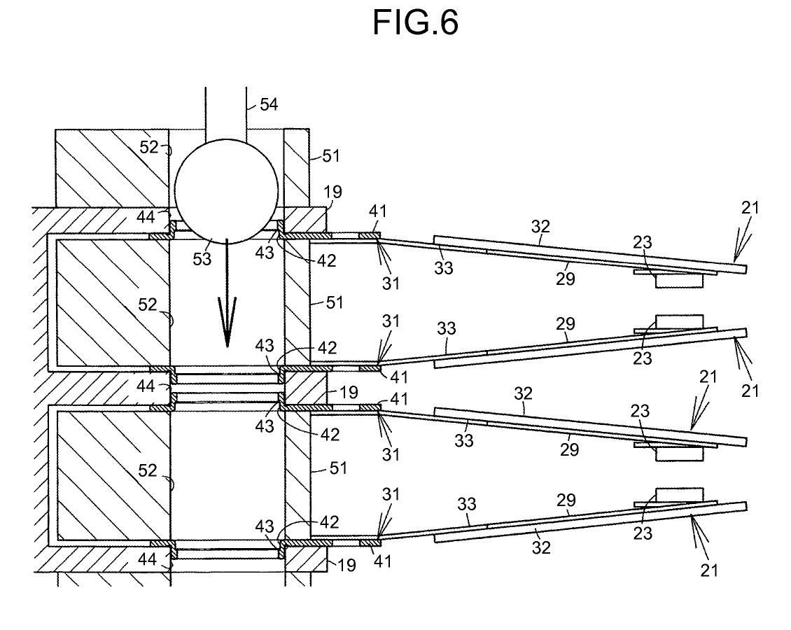

As illustrated in FIG. 6, to the caulking hole 44 of the carriage arm 19, the boss 43 of the base plate 31 is fitted. The base plate 31 and the carriage arm 19 are sandwiched by flat surfaces of jigs 51. The jigs 51 act so that the base plate body 41 is pressed to the front surface and the rear surface of the carriage arm 19. In each of the jigs 51, a through hole 52 having the inner diameter, for example, same as that of the caulking hole 44 is formed. The central axis of the through hole 52 matches with that of the caulking hole 44. At this time, into the through hole 42 of the base plate body 41, a metallic ball 53 for caulking is pushed. Upon the pushing, a caulking pin 54, for example, is used.

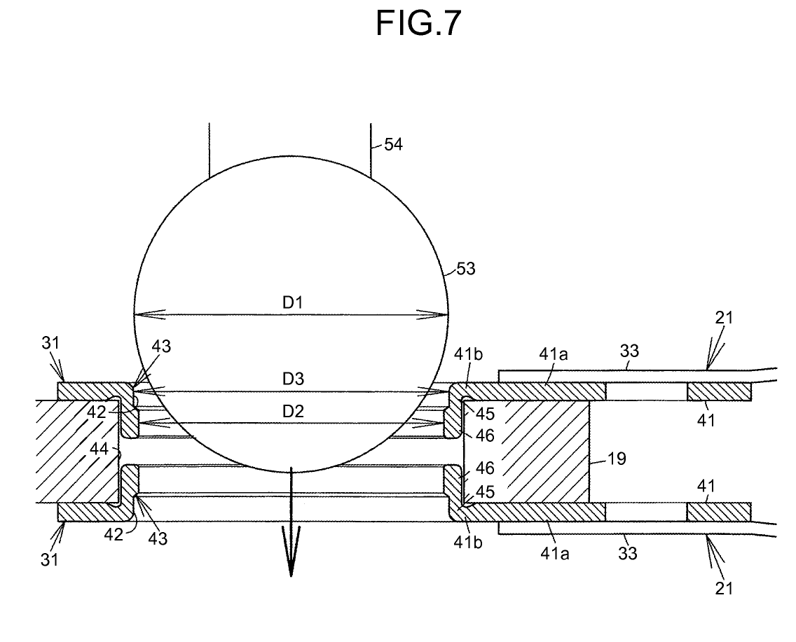

As illustrated in FIG. 7, the diameter D1 of the metallic ball 53 is set larger than the inner diameter D2 of the flange 46. The diameter D1 of the metallic ball 53 has to be set smaller than the inner diameter D3 of the base 45. A caulking margin is equivalent to a half of a value obtained by subtracting the diameter D2 from the diameter D1. The caulking margin is set to, for example, about 30 μm to 50 μm. In this embodiment, the caulking margin is set to, for example, 32 μm. Since the thickness T of the flange 46 is always set to a constant value upon setting these ratios R1 and R2 as described above, the caulking margin is always set to a constant value.

As the metallic ball 53 is pushed, the metallic ball 53 is gradually contacts the flange 46. The flange 46 is pressed toward the inner peripheral surface of the caulking hole 44. The flange 46 plastically deforms. The flange 46 is pressed to the inner peripheral surface of the caulking hole 44 with a sufficient pressing force. Accordingly, the boss 43 is fixed in the caulking hole 44 of the carriage arm 19 with a sufficient fixing force. At this time, to the caulking pin 54 and then to the metallic ball 53, supersonic vibration is applied. Consequently, contact friction between the metallic ball 53 and the flange 46 is reduced. Accordingly, the head suspension assembly 21 is attached to the carriage arm 19.

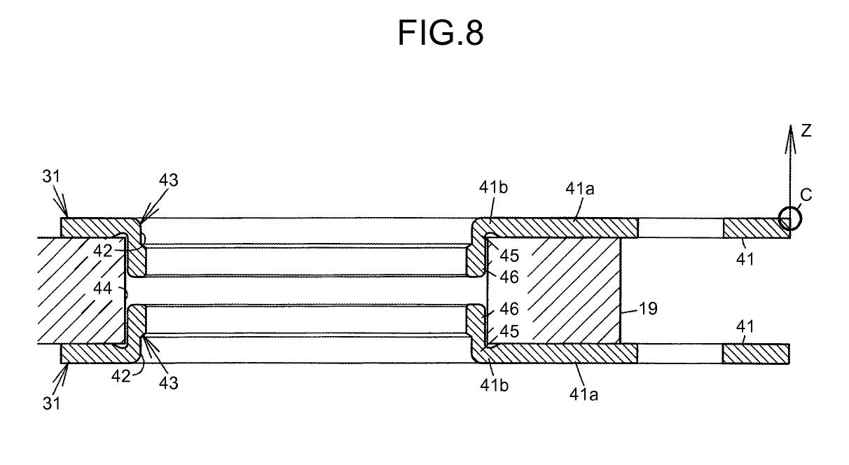

Next, the effects of the shape of the boss 43 are verified. For the verification, a simulation was performed. In the simulation, the warpage of the base plate body 41 generated at the time of pushing the metallic ball 53. The caulking margin is set to, for example, about 32 μm. As illustrated in FIG. 8, the warpage of the base plate body 41 was measured as an angle C at the front end of the base plate body 41. The direction of the warpage is defined to a vertical direction Z orthogonal to the surface of the carriage arm 19. Upon measuring the warpage, the length L1 and the length L2 were set to constant values. At this time, the thickness was changed.

In this case, reduce ratio [%] of the warpage were measured with different coefficients of friction. Upon measuring the reduce ratio [%], the warpage amount when the coefficient of friction between the metallic ball 53 and the flange 46 is set to 0.1 and the warpage amount when the coefficient of friction is set to 0.01 were compared. The case where the coefficient of friction is set to 0.01 may be, for example, a case where supersonic vibration is applied to the metallic ball 53 or a case where lubricant is applied to the metallic ball 53. On the other hand, the case where the coefficient of friction is set to 0.1 may be, for example, a case where nothing is applied to the metallic ball 53.

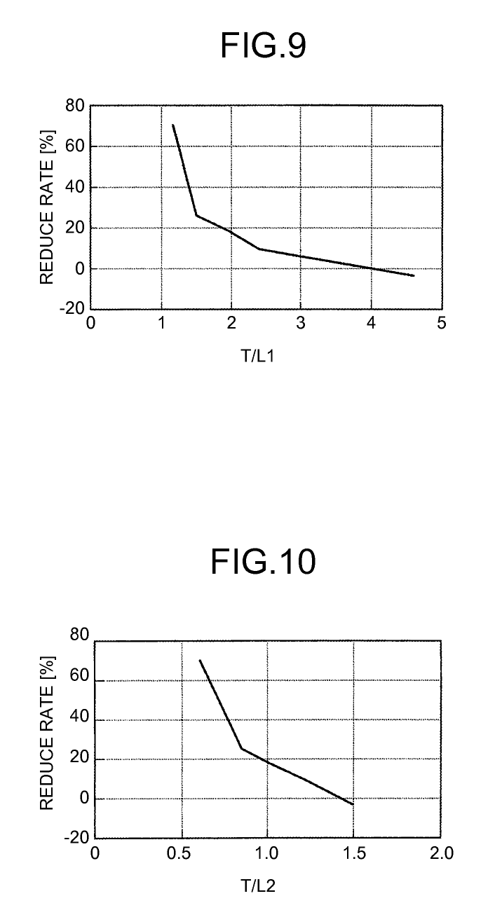

Consequently, as illustrated in FIG. 9, as the ratio R1 of the thickness T to the length L1 decreased, the reduce ratio [%] of the warpage of the base plate body 41 increased. By the simulation, it was verified that when the ratio R1 of the thickness T to the length L1 is set to, for example, 1.5 or less, the reduce ratio [%] of the warpage becomes particularly preferable. Accordingly, it was verified that when the ratio R1 of the thickness T to the length L1 is set in a predetermined range, the warpage of the base plate body 41 is significantly reduced as the coefficient of friction is reduced. It was verified that as a result of suppression of deformation of the boss 43 based on the setting of the ratio R1, pulling of the base plate body 41 into the caulking hole 44 is suppressed. It was verified that as a result of the suppression, the warpage of the base plate body 41 is reduced.

Similarly, as illustrated in FIG. 10, as the ratio R2 of the thickness T to the length L2 decreased, the reduce ratio [%] of the warpage of the base plate body 41 increased. By the simulation, it was verified that when the ratio R2 of the thickness T to the length L2 is set to, for example, 0.8 or less, the reduce ratio [%] of the warpage becomes particularly preferable. Accordingly, it was verified that when the ratio R2 of the thickness T to the length L2 is set in a predetermined range, the warpage of the base plate body 41 is significantly reduced as the coefficient of friction is reduced. It was verified that as a result of suppression of deformation of the boss 43 based on the setting of the ratio R2, pulling of the base plate body 41 into the caulking hole 44 is suppressed. It was verified that as a result of the suppression, the warpage of the base plate body 41 is reduced.

The base plate for the head suspension of the aforementioned embodiment contributes to realizing the aforementioned head gimbal assembly.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A head gimbal assembly comprising:
a base plate body substantially having a plate shape, said plate body comprising:
a through hole passing through the base plate body from a front surface to a rear surface thereof;
a substantially cylindrical base that rises from the front surface of the base plate body, encircles the through hole, and has a first inner diameter;
a substantially cylindrical flange connected to the cylindrical base that encircles the through hole and has a second inner diameter smaller than the first inner diameter; and
an inner wall surface that is defined by the flange around the through hole and that extends along a substantially cylindrical surface having a central axis substantially parallel to a central axis of the through hole;
a load beam connected to a front end of the base plate body; and
a flexure fixed to a surface of the load beam, wherein
a ratio of a thickness T of the flange defined along a plane orthogonal to the central axis of the through hole to a length L of the inner wall surface defined in a direction parallel to the central axis of the through hole is 1.5 or less.

2. A head gimbal assembly comprising:
a base plate body substantially having a plate shape;
a through hole passing through the base plate body from a front surface to a rear surface;
a substantially cylindrical base that rises from the front surface of the base plate body, encircles the through hole, and has a first inner diameter; and
a substantially cylindrical flange connected to the cylindrical base that encircles the through hole and has a second inner diameter smaller than the first inner diameter;
a load beam connected to a front end of the base plate body; and
a flexure fixed to a surface of the load beam, wherein
a ratio of a thickness T of the flange defined along a plane orthogonal to a central axis of the through hole to a length L of the flange defined in a direction parallel to the central axis of the through hole is 0.8 or less.

3. A fixing method of a base plate and a carriage arm, the method comprising:
fitting, into a caulking hole formed in the carriage arm, a boss formed around a through hole passing through a base plate body from a front surface to a rear surface thereof, the base plate body substantially having a plate shape; and
moving a ball in the through hole and the caulking hole while reducing friction between the boss and the ball,
wherein the boss comprises:
a substantially cylindrical base that rises from the front surface of the base plate body, and has a first inner diameter;
a substantially cylindrical flange connected to the cylindrical base that encircles the through hole and has a second inner diameter smaller than the first inner diameter; and
an inner wall surface that is defined by the flange around the through hole and that extends along a substantially cylindrical surface having a central axis substantially parallel to a central axis of the through hole, and
wherein a ratio of a thickness T of the flange defined along a plane orthogonal to the central axis of the through hole to a length L of the inner wall surface defined in a direction parallel to the central axis of the through hole is 1.5 or less.

4. The fixing method of a base plate and a carriage arm of claim 3, wherein reducing friction comprises applying supersonic vibration to the ball and the boss.

5. The fixing method of a base plate and a carriage arm of Claim 3, wherein reducing friction comprises applying lubricant to the boss.

6. A fixing method of abase plate and a carriage arm, the method comprising:
fitting, into a caulking hole formed in the carriage arm, a boss formed around a through hole passing through a base plate body from a front surface to a rear surface thereof, the base plate body substantially having a plate shape; and
moving a ball in the through hole and the caulking hole while reducing friction between the boss and the ball,
wherein the boss comprises:
a substantially cylindrical base that rises from the front surface of the base plate body, and has a first inner diameter;
a substantially cylindrical flange connected to the cylindrical base that encircles the through hole and has a second inner diameter smaller than the first inner diameter; and
an inner wall surface that is defined by the flange around the through hole and that extends along a substantially cylindrical surface having a central axis substantially parallel to a central axis of the through hole, and
wherein a ratio of a thickness T of the flange defined along a plane orthogonal to the central axis of the through hole to a length L of the flange defined in a direction parallel to the central axis of the through hole is 0.8 or less.

7. The fixing method of a base plate and a carriage arm of claim 6, wherein the reducing friction comprises applying supersonic vibration to the ball and the boss.

8. The fixing method of a base plate and a carriage arm of claim 6, wherein the reducing friction comprises applying lubricant to the boss.
